(19) United States
(12) Patent Application Publication
(10) Pub. No.: US 2009/0170390 A1
(43) Pub. Date: Jul. 2, 2009

(54) Doctor Blade Used For Resin Finishing On A Cloth And Method For Resin Finishing With Use Of It

(76) Inventor: Masatomi Goto, Kyoto (JP)

Correspondence Address: HODGSON RUSS LLP;THE GUARANTY BUILDING, 140 PEARL STREET, SUITE 100, BUFFALO, NY, 14202-4040, US

(21) Appl. No.: 12/304,574

(22) PCT Filed: Jun. 4, 2007
(86) PCT No.: PCT/JP2007/061305

§ 371 Date: Mar. 11, 2009

(30) Foreign Application Priority Data
Jun. 16, 2006 (JP) 2006-166793
Oct. 4, 2006 (JP) 2006-272382

(51) Int. Cl. B32B 27/12; B05C 1/14; B05D 1/40

(52) U.S. Cl. 442/79; 118/261; 427/412

(57) ABSTRACT

A new doctor blade by which resin finishing can be stably applied to such a thin cloth having a weight 120 g/m² or less is provided. The doctor blade has a lower portion bent to form an inclined surface so as to supply a resin composition on the inclined surface of the blade and to coat the resin composition on a cloth moving from the blade tip side to the blade body side, the lower portion 3 of the blade 1 in a width of 2-12 cm being bent to make an angle of 110-160 degrees to the blade body (upper portion 4). The tip portion 5 of the lower portion 3 of the blade 1 may be bent backward in a width of 3-10 mm at an angle of 50-150 degrees to the lower portion 3 of the blade.

### TECHNICAL FIELD

The invention relates to a doctor blade by which resin finishing can be effectively applied to only surface of a cloth and relates to a method for resin finishing with use of it.

### BACKGROUND

Various methods for providing water repellency and water absorbability to only one surface of a cloth have been tried. For example, Pat. Document 1 describes a method for producing a partial water absorbent woven or knitted fabric for inner wears in which the front surface has water repellency but the back surface has water absorbability, by applying a water repellent only to one surface of the woven or knitted fabric. Examples of it disclose that a water repellent is applied to an interlock knitted fabric having a weight of 230 g/m² by spraying method and that a water repellent is coated on a plain weave fabric of 100% polyester finished yarn having a weight of 250 g/m² by a reverse-roll coater.

Pat. Document 2 discloses, as a method for applying water absorbability to only one surface of a cloth, that a water absorbing agent is roller-printed on an interlock knitted fabric of polyester finished yarn having a weight of 200 g/m² in Example 1, and that a 3% solution of a water repellent is coated on a plain weave fabric of a blended yarn of polyester and cotton having a weight of 240 g/m² in Example 2.

Further, Pat. Document 3 discloses a water repellent is roller-printed on one surface of a cloth to apply water repellency only to the convex surface portion, and in Examples, a sheeting knitted fabric of 100% cotton having a weight of 130 g/m² and a sheeting knitted fabric of a blended yarn of cotton and polyester having a weight of 140 g/m² are used. Pat. Document 4 discloses that a water repellent is applied to one surface of a cloth by a floating knife coater. However, as illustrated in Figures, the used doctor blade is merely usual plain board, by which the coated resin is squeezed through to the back surface and accordingly it is difficult to apply a resin finish to only one surface.

[Pat. Document 1] JP S56-144272 A

[Pat. Document 2] JP S58-220873 A

[Pat. Document 3] JP H01-53394 A

[Pat. Document 4] JP 2004-523673 A

### DISCLOSURE OF THE INVENTION

### Problems to be Solved in the Invention

An object of the invention is to provide a new doctor blade and a new resin coating method, in which a resin finish is surely applied to only one surface of such a thin cloth having a weight of 120 g/m² or less, particularly 60 g/m² or less.

### Means to Solving the Problems

The present inventor has studied various shapes of a doctor blade, and found that, by making a doctor blade to have a special shape, a resin finish is surely applied to a surface of very thin cloths without squeezing through the used resin to the back surface. In the result the above problems have been dissolved.

Namely a doctor blade according to the present invention and a coating method (resin finishing method) with use of the doctor blade are as follows.

(1) A doctor blade has a lower portion bent to form an inclined surface so as to supply a resin composition on the inclined surface of the blade and to coat the resin composition on a cloth moving from the blade tip side to the blade body side. The lower portion of the blade in a width of 2-12 cm is bent to make an angle of 110-160 degrees to the blade body.

(2) In the doctor blade of the above (1), the tip having 3-10 mm width of the lower portion of the blade is bent backward at an angle of 50-150 degrees to the lower portion of the blade.

(3) A method for resin finishing, in which a resin composition composed of an aqueous emulsion is applied to only the surface of the used cloth by a floating knife coater, is carried out by using a doctor blade in the above (1) or (2).

(4) In the method for resin finishing of the above (3), the cloth is a woven fabric, knitted fabric or non-woven fabric having water absorbability, and the resin composition has a viscosity of 6000 cps or more (preferably 12000 cps or more, more preferably 15000 cps or more).

(5) In the method for resin finishing of the above (4), the resin composition is composed of a water repellent.

(6) In the method for resin finishing of the above (3), the cloth is a woven fabric, knitted fabric or non-woven fabric poor in water absorbability, and the resin composition has a viscosity of 3000-6000 cps (preferably 3500-5000 cps).

(7) In the method for resin finishing of the above (6), the cloth is a water repellent finished cloth, and the resin composition is that for waterproof coating.

(8) In the method for resin finishing of anyone of the above (3)-(7), the cloth is a thin cloth having a weight of less than 130 g/m².

(9) In the method for resin finishing of the above 3, the resin composition is coated on a surface of the cloth moving it upward inclined.

(10) A resin-finished cloth, in which one surface has water repellency and the other surface has water absorbability, is obtained by applying a water repellent to one surface of a water absorbing cloth having a weight of less than 130 g/m² with the method of the above (3).

(11) A resin-finished cloth, in which the front and back surfaces have water repellency and the middle layer has water absorbability, is obtained by applying a water repellent to the front and back surfaces of a water absorbing cloth having a weight of 100-450 g/m² with the method of the above (3).

Doctor blades of the present invention may have a width and a length similar to those used in conventional coating method. However, by bending the lower portion of the doctor blade, i.e. the side contacted with the cloth to be treated, frontward to the blade body to drop the resin on the cloth from the inclined area so that the resin is uniformly coated on the cloth in the state of cylindrically rolling the resin at the tip portion of the inclined area, it is possible to uniformly coat the resin only on the front surface of such a thin cloth as having a weight of less than 130 g/m², 60 g/m² or less without squeezing through to the back surface.

The width of the inclined lower portion of the blade may be about 2-12 cm, preferably 3.5-9 cm. The bending angle of the lower portion of the blade to the body of the blade may be 110-160 degrees, preferably 120-150 degrees. According to the invention, the cloth is resin-finished (coated) by contacting the tip portion of the blade to the cloth moving from the tin side to the body side of the blade.

The lower tip of the blade may be deformed depending on the used cloth and the viscosity of the used resin composition. For example, 3-10 mm width of the lower tip of the blade is bent backwards at an angle of 50-150 degrees to the lower portion of the blade so that, when the blade is set at the vertical position to the treating cloth, the tip of the blade is contacted with the cloth at an angle of about 90-20 degrees.

According to the invention, resin compositions may be fed on the inclined tip portion of the blade, and accordingly the resin compositions (resin liquids or pasts) are cylindrically rotated at the tip portion of the blade contacted with the cloth and uniformly contacted with the whole width of the cloth so that an even thin film can be effectively coated.

It is preferred to apply resin finish by a floating knife coater with use of resin compositions composed of an aqueous emulsion, and in the case of using a woven, knitted or non-woven fabric having water absorbability as the cloth, the viscosity of the used resin composition is preferably 1500 cps. As the woven, knitted or non-woven fabric having water absorbability, for example, a cloth of fibers having naturally water absorbability, such as cellulose fibers, may be used, but a cloth of fibers poor in water absorbability may be used after treating it by water absorbent to give water absorbability.

In the case, any resin compositions may be used, but those comprising water repellent such as silicone compounds, fluoride compounds and the like can be very effectively used.

When the used cloth is a woven, knitted or non-woven fabric poor in water absorbability, the preferable viscosity of the resin composition is 3000-5000 cps. A cloth having water absorbability is treated by water repellent and then may be used. In the case, the pretreated cloth is effectively used to coat a resin composition for water proof on one surface of it.

The invention may be effectively applied to such a thin cloth as having a weight of less than 130 g/m², particularly 100 g/m² or less to coat a resin on only one surface of the cloth. Accordingly, very thin cloths, such as organdie and georgette can be finished to have water repellency on one surface but water absorbability on the other surface.

In the case of relative thick cloths having a weight of 100 g/m² or more, for example 200 g/m² or 400 g/m², water repellent can be applied to the both surfaces of the cloth to obtain a product in which the both surfaces have water repellency and the inner layer has water absorbability.

As described above, according to the invention a surface water-repellent finished cloth in which the inner layer maintains water absorbability can be stably produced by applying a water repellent only on the surface of water absorbing cloth. In the surface water-repellent finished cloth, a drop of water is contacted with the surface having water repellency and immediately absorbed and spread in the lower layer having water absorbability with capillary action. Accordingly when clothes are produced with use of the surface water-repellent finished cloth, by wearing the clothes to contact the inner side having water-repellency with skin, sweat is not remained on skin because it is immediately transferred to the other layer with capillary action, and accordingly the surface contacted with skin is always maintained comfortable.

The surface water-repellent finished cloth having water repellent surface used for clothes may be that produced by applying water repellent only to one surface of a cloth or by applying water repellent to the both surfaces of a cloth to maintain the inner layer water absorbing. In the former case, a water-absorbing cloth having a weight of about 80-300 g/m² may be used and water repellent is applied to the cloth so as to make one surface water repellency and the other surface water absorbability. On the other hand, in the latter case, a water-absorbing cloth having a weight of about 100-450 g/m², preferably about 130-400 g/m² and the cloth is treated to make the both surfaces having water repellency and the middle layer having water absorbability. In the clothes produced by using the finished cloth, sweat is quickly absorbed and spread from the water repellent inner surface contacted with skin to the middle layer having water absorbability. Because the outer surface also has water repellency, the absorbed sweat is not squeezed trough to the outer surface. Accordingly, in the clothes produce by using the finished cloth, the surface contacted with skin is always comfortable and the outer surface is not stained with sweat. The appearance is always maintained fresh. Since air permeability is not decreased by water repellent finishing, drying is well.

The water absorbing cloths may be constituted of fibers having wettability of water. Among them, there are included natural fiber products and chemical fiber products. The cloths constituted of mainly cellulose fibers (cotton, hemp, rayon and the like) or fibers mainly comprising cellulose fibers are preferably used. The blended cloths, union cloths (woven fabrics or knitted fabrics) of cellulose fibers and chemical fibers may be used.

On the other hand, by producing clothes with a thin finished cloth having water repellency only on the front surface in a manner as the surface having water repellency is positioned outer side and the inner side has water absorbability, comfortable clothes can be obtained in which the skin side has good feeling and air permeability naturally possessed in the fibers and the outer side has water repellency and stain-proofing property.

Among the clothes produced with use of such a one-surface water repellent finished cloth, there are comprised underwear, brassiere, sports wear, working wear, hats, gloves, sweat-removing pads, shirts, blouses, shorts, pants and the like. Further, the finished cloth in which the both surfaces has water repellency but the middle layer has water absorbability is very useful as sports wear, swimming suits, sweat-removing pads and the like, because the both surfaces do not feel wet and the middle layer absorbs water.

### BRIEF DESCRIPTION OF DRAWINGS

FIG. 1 shows an example of resin finishing method according to the invention.

FIG. 2 is a side view of a doctor blade according to the invention.

FIG. 3 explains a resin finishing method of the invention.

FIG. 4 is an enlarged cross section of a finished cloth obtained in the invention.

### DESCRIPTION OF SIGNS

1 blade

2 cloth

3 lower portion

4 upper portion

5 tip portion

6 resin composition

7 part having water absorption

8 part having water repellent

### DETAILED DESCRIPTION OF THE INVENTION

### Best Mode for Carrying out the Invention

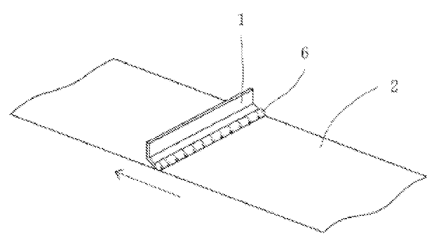

According to the invention, for example, it is preferred to carrying out the resin finishing, in such a manner as shown in FIG. 1, with a floating knife coater in which a cloth 2 is moved in the state of floating in the air at the contacting portion with the doctor blade 1

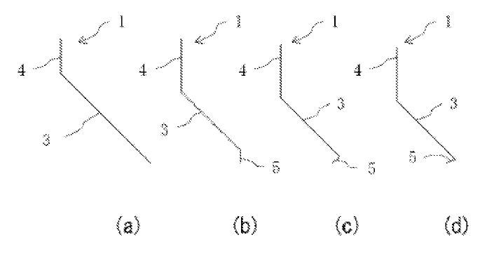

As the doctor blade 1, as exemplified in FIG. 2, the desired object is attained by using that in which the lower portion of a flat doctor blade is inclined forward at an angle of 110-160 degrees to the body of the blade. Depending upon the purpose of the resin finishing, the tip of the blade may be bent backward at an angle of 50-150 degrees to the lower portion of the blade.

For example, the blade 1 in FIG. 2 (a) is composed with a flat steel board having 95 mm width, 2000 mm length and 2 mm thickness. The lower portion 3 of 75 mm width is bent forward at 135 degrees against the upper portion 4 of 20 mm width.

The blade 1 in FIG. 2 (b) is composed of a flat steel board having 85 mm width, 2000 mm length and 2 mm thickness. The lower portion 3 is bent forward at an angle of 135 degrees to the upper portion of 30 mm width, and the tip portion 5 (5 mm width) of the under portion 3 is bent backward at an angle of 135 degrees against to the lower portion. The tip portion 5 becomes parallel to the upper portion 4.

The blade 1 in FIG. 2 (c) is composed of a flat steel board having 85 mm width, 2000 mm length and 2 mm thickness. The lower portion 3 is bent forward at an angle of 135 degrees to the upper portion of 30 mm width, and the tip portion 5 (5 mm width) of the under portion 3 is bent backward at an angle of 85 degrees to the lower portion.

The blade 1 in FIG. 2 (d) is composed of a flat steel board having 85 mm width, 2000 mm length and 2 mm thickness. The lower portion 3 is bent forward at an angle of 135 degrees to the upper portion of 30 mm width, and the tip portion 5 (5 mm width) of the under portion 3 is bent backward at an angle of 68 degrees to the lower portion.

As shown in FIG. 1, these blades 1 are used in the manner as contacting the tip portion 5 with the cloth 2 sent in the direction of the arrow to coat the resin composition 6 on the cloth 2 with the tip of the lower portion 3 inclined to form a thin coating layer. In the case, since the lower portion 3 of the blade 1 is inclined frontward, as shown in FIG. 1, the resin composition 6 is uniformly contacted with the cloth 2 at the whole width of the tin portion 5 of the blade 1 with rotating clockwise to form a thin coating having a high quality.

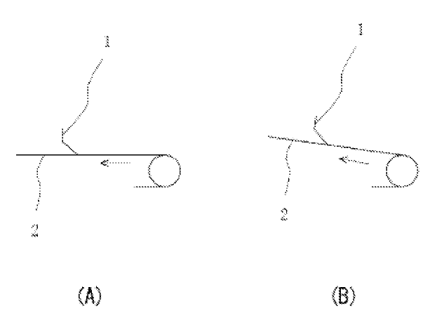

Generally, the cloth 2 is horizontally moved for coating as shown in FIG. 3-A. However, in the case of using a very thin cloth 2, as shown in FIG. 3-B, the coating may be carried out on the cloth 2 moved with upward inclination at an angle of 3-10 degrees. In the latter case, as shown in FIG. 2(a), a blade in which the tip is not bent backward (namely the lower portion 3 is merely bent frontward) is preferably used.

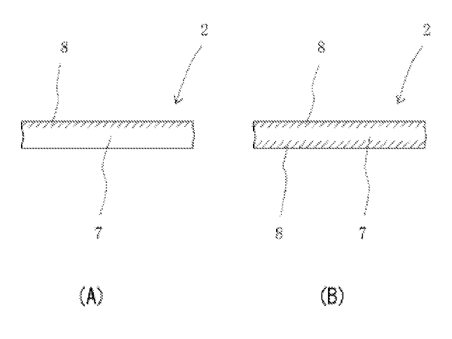

By the coating method as in the invention, as disclosed in FIG. 4, in the case of using a cloth 2 having water absorbability, even if the cloth 2 is very thin, water repellent is applied to only surface to obtain finished cloth superior in functional properties, which has both of water absorbing portion 7 and water repellent portion 8.

### EXAMPLE 1

Examples are described as follows:

A resin composition for water-repellent treatment was prepared with use of a fluorine-contained resin (trademark: TEFLON) and the following method was carried out.

1) On a cloth (cotton cloth for pants: 200 g/m²), a resin composition having a viscosity of 6000-6500 cps was coated with use of a blade of FIG. 2(b) in the method of FIG. 3-A, dried and heat-treated. In the result, a product in which the front surface had water repellency but the back surface had a water absorbability inherent in cotton could be obtained (See FIG. 4-A).

2) On a cloth (cotton cloth for a shirt: 120 g/m²), a resin composition having a viscosity of 15000 cps was coated with use of a blade of FIG. 2(b) in the method of FIG. 3-A, dried and heat-treated. In the result, a product in which the front surface had water repellency but the back surface had water absorbability inherent in cotton could be obtained (See FIG. 4-A).

3) On a cloth (cotton lawn cloth: 70 g/m²), a resin composition having a viscosity of 18000 cps was coated with use of a blade of FIG. 2(a) in the method of FIG. 3-B (inclination of cloth: 5 degree), dried and heat-treated. In the result, a product in which the front surface had water repellency but the back surface had water absorbability inherent in cotton could be obtained (See FIG. 4-A).

4) On a cloth (cotton non-woven fabric: 200 g/m²), a resin composition having a viscosity of 6000-6500 cps was coated with use of a blade of FIG. 2(b) in the method of FIG. 3-A, dried and heat-treated, and then the same coating was applied on the back surface of the cloth. In the result, a functional finished cloth in which both of the front and back surfaces had water repellency but the middle layer had water absorbability (See FIG. 4-B).

### EXAMPLE 2

On a cloth treated by water-repellent finishing, an acryl resin composition generally used for waterproof finish of an umbrella was coated.

1) On a polyester satin (weight: 127 g/m²) treated by water-repellent finishing, a resin composition having a viscosity of 4000-4500 cps was coated with use of a blade of FIG. 2(c) in the method of FIG. 3-A. In the result, an umbrella cloth having an excellent waterproof was obtained in which one surface has water repellency and feeling natural in the cloth.

2) On a polyester organdie (weight: 40 g/m²) treated by water-repellent finishing, a resin composition having a viscosity of 3500-4000 cps was coated with use of a blade of FIG. 2(b) in the method of FIG. 3-A. In the result, although the cloth was very thin, an umbrella cloth having an excellent waterproof, in which one surface had water repellency and feeling natural in the cloth, without squeezing the resin composition through to the surface.

3) On a cotton broadcloth (weight: 113 g/m²) treated by water-repellent finishing, a resin composition having a viscosity of 4000-5000 cps was coated with use of a blade of FIG. 2(c) in the method of FIG. 3-A. In the result, a rein layer having a thickness of about ⅔ of the cloth was formed by the resin composition, so that an umbrella cloth had an excellent waterproof in which one surface had water repellency and feeling natural in the cloth.

4) On a cloth composed of a polyester/cotton (50:50) core spun yarn and having a see-through pattern produced by opal finishing to remove cotton according to the design, water repellent finishing was applied and then a resin composition having a viscosity of 4000-5000 cps was coated with use of a blade of FIG. 2(c) in the method of FIG. 3-A. In the result, though the cloth had a see-through pattern, an all-weather umbrella superior in waterproof was obtained in the state of that a coating layer superior in waterproof was effectively formed by the resin composition on surface of the cloth but one surface had water repellency and feeling inherent in opal finishing cloth.

The viscosity described in the specification is a value obtained at room temperature (about 25° C.) by VISCOTESTER-VT-04F manufactured in RION.

With use of a resin composition for water repellent treatment in which fluorine-contained resin (trademark: TEFLON) was used, a surface water repellent finishing cloth was obtained in which the surface had water repellency but the other surface or the middle layer had water absorbability.

1) On a cloth (cotton knitted fabric: 200 g/m²), a resin composition having a viscosity of 18000 cps was coated with use of a blade of FIG. 2(a) in the method of FIG. 3-B (an angle of inclination of the cloth: 5 degrees), dried and heat-treated. In the result, a product in which the front surface had water repellency but the back surface had water absorbability.

2) On the front surface of a cloth (cotton knitted fabric: 200 g/m²), a resin composition having a viscosity of 6000-6500 cps was coated with use of a blade of FIG. 2(b) in the method of FIG. 3-A, dried and heat-treated, and then on the back surface of the cloth, same coating was applied. In the result, a product in which the front and back surfaces had water repellency but the middle layer had water absorbability was obtained.

3) On a cloth (cotton cloth for a shirt: 120 g/m²), a resin composition having a viscosity of 15000 cps was coated with use of a blade of FIG. 2(b) in the method of FIG. 3-A, dried and heat-treated to obtain a product in which the front surface had water repellency but the back surface had water absorbability inherent in cotton.

Next, with use of the finished cloths, clothes in which the inner side was water repellent were made.

With use of the product 1), sporting shorts were made in which the side contacted with skin was water repellent. When a man wore the shorts and jogged, the man sweated but the inner side of the shorts was not wet and the sweat was immediately absorbed and dispersed in the front side having water absorbability. In the result, the inner side of the shorts was always maintained dry and comfortable.

With use of the product 2), a sporting shirt for running was made. When a man wore the shirt, the man sweated but the inner side contacted with skin was always maintained dry and comfortable, and sweat was absorbed and dispersed in the middle layer and the surface was not stained with sweat. Further the sweat absorbed and dispersed in the middle layer was immediately dried through the front surface.

With use of the product 3), a shirt was made. When a man wore the shirt and sweated, the side contacted with skin was maintained dry. Accordingly even in the condition of restricting the air-conditioning in the building, the man could be staying comfortable.

### EXAMPLE 4

On a knitted fabric (weight: 130 g/m²) consisting of a cotton cloth with a 5 percent polyurethane mix, a resin composition-fluorine-contained resin (trademark: TEFLON) having a viscosity of 18000 cps was coated with use of a blade of FIG. 2(a) in the method of FIG. 3-B (inclination of cloth: 5 degree), dried and heat-treated. In the result, a product in which the front surface had water repellency but the back surface had water absorbability can be obtained.

With use of thus obtained surface water repellent finished cloth, a long-sleeve shirt was made to place the water repellent surface outside.

The clothes-inside-humidity of the shirt A in the state of wearing was compared with that of the shirt B which was made of a product obtained by applying water repellent entirely to same cloth with general method. In the shirt A of the surface water-repellent finished cloth according to the invention, the heat was not closed in the space between the clothes and skin on each of resting time and sporting time, and the clothes were maintained comfortable. The clothes-inside-humidity (absolute humidity) did not exceed substantially 30 mmHg even after sporting, and decreased to 25 mmHg or less, namely comfortable humidity, for a few minutes. On the other hand, with the shirt B of a cloth in which water repellent was squeezed through to the back surface according to general water repellent finishing, the clothes-inside-humidity (absolute humidity) was increased to near of 40 mm Hg, and then some time is necessary until decreasing it to 30 mm Hg or less, and therefore heat was closed in the space between clothes and skin so that the clothes was not comfortable.

1. A doctor blade which has a lower portion bent to form an inclined surface so as to supply a resin composition on the inclined surface of the blade and to coat the resin composition on a cloth moving from the blade tip side to the blade body side, the lower portion of the blade in a width of 2-12 cm being bent to make an angle of 110-160 degrees to the blade body.

2. The doctor blade as defined in claim 1, in which the tip having 3-10 mm width of the lower portion of the blade is bent backward at an angle of 50-150 degrees to the lower portion of the blade.

3. A method for resin finishing in which a resin composition composed of an aqueous emulsion is applied to only the surface of the used cloth by a floating knife coater, characterized in using a doctor blade as defined in claim 1.

4. A method for resin finishing as defined in claim 3, wherein the cloth is a woven fabric, knitted fabric or non-woven fabric having water absorbability, and the resin composition has a viscosity of 6000 cps or more.

5. A method for resin finishing as defined in claim 4, wherein the resin composition is composed of a water repellent.

6. A method for resin finishing as defined in claim 3, wherein the cloth is a woven fabric, knitted fabric or non-woven fabric poor in water absorbability, and the resin composition has a viscosity of 3000-6000 cps.

7. A method for resin finishing as defined in claim 6, wherein the cloth is a water repellent finished cloth, and the resin composition is that for waterproof coating.

8. A method for resin finishing as defined in claim 3, wherein the cloth is a thin cloth having a weight of less than 130 g/m².

9. A method for resin finishing as defined in claim 3, wherein the resin composition is coated on a surface of the cloth moving it upward inclined.

10. A resin-finished cloth in which one surface has water repellency and the other surface has water absorbability, characterized in that it is obtained by applying a water repellent to one surface of a water absorbing cloth having a weight of less than 130 g/m² with the method as defined in claim 3.

11. A resin-finished cloth in which the front and back surfaces have water repellency and the middle layer has water absorbability, characterized in that it is obtained by applying a water repellent to the front and back surfaces of a water absorbing cloth having a weight of 100-450 g/m² with the method as defined in claim 3.
